(19) United States
(12) Patent Application Publication
(10) Pub. No.: US 2015/0377312 A1
(43) Pub. Date: Dec. 31, 2015

(54) PARTITIONED ELASTOMERIC JOURNAL BEARING ASSEMBLIES, SYSTEMS AND METHODS

(71) Applicant: LORD CORPORATION, Cary, NC (US)

(72) Inventors: Donald D. RUSSELL, Fairview, PA (US); David M. CATANZARITE, Edinboro, PA (US); Mark A. SMIALOWSKI, Erie, PA (US)

(21) Appl. No.: 14/767,517

(22) PCT Filed: Feb. 25, 2014
(86) PCT No.: PCT/US2014/018273

§ 371 Date: Aug. 12, 2015

Related U.S. Application Data
(60) Provisional application No. 61/768,865, filed on Feb. 25, 2013.

(51) Int. Cl. F16F 1/38; F16C 27/06

(52) U.S. Cl. CPC F16F 1/3835; F16C 27/063; F16F 1/3856

(57) ABSTRACT

Elastomeric journal bearing assemblies, systems, and methods are provided in which and at least one structural element is arranged between adjacent pairs of a plurality of elastomer sections arranged about a center axis. In such arrangements, the disclosed assemblies, systems, and methods redistribute stresses throughout the depth of elastomeric journal bearing more efficiently than conventional configurations.

### CROSS REFERENCE TO RELATED APPLICATIONS

This application relates and claims priority to U.S. Provisional Patent Application Ser. No. 61/768,865 filed Feb. 25, 2013, the disclosure of which is incorporated by reference herein in its entirety.

### TECHNICAL FIELD

The subject matter disclosed herein relates generally to bearing assemblies used to control movement/vibration in a mechanical system or the like. More particularly, the subject matter disclosed herein relates to elastomeric journal bearing assemblies, systems and methods.

### BACKGROUND

Fluid elastomeric dampers utilize elastomeric journal bearings with elastomer sections that are prone to separation of the elastomer due to direct tensile stress and localized bending. The direct tensile stress and localized bending typically occurs in thick elastomer sections and is induced by the increased elastomer section thickness required for the design motions. An exemplary elastomeric journal bearing is illustrated in FIG. 1. In FIG. 1, an elastomeric journal bearing, generally designated 10, couples a shaft to a surrounding housing such that movement of the shaft relative to the housing is damped. Unitary elastomer section 12 having a substantially annular, cylindrical shape provides stiffness and damping. Such journal bearing designs have reduced useful service lives due to the direct tensile stress and localized bending of the thick elastomer sections. For example, FIGS. 2A and 2B illustrate the high principle stresses and strains that can develop within the elastomeric journal bearing during normal operation. As a result, it would be desirable for an elastomeric journal bearing design to alleviate the impact of these direct tensile stresses and areas of localized bending without compromising the effectiveness of the elastomeric journal bearing.

### SUMMARY

In accordance with this disclosure, elastomeric journal bearing assemblies, systems, and methods are provided. In one aspect, an elastomeric journal bearing assembly comprises a plurality of elastomer sections arranged about a center axis and at least one structural element arranged between an adjacent pair of the plurality of elastomer sections.

In another aspect, an elastomeric journal bearing system comprises a bearing housing, a shaft positioned within the bearing housing and movable with respect to the bearing housing, a plurality of elastomer sections arranged within the bearing housing about the shaft, and at least one structural element arranged between adjacent pairs of the plurality of elastomer sections.

In yet another aspect, a method for making an elastomeric journal bearing comprising arranging a plurality of elastomer sections within a bearing housing about a shaft that is positioned within the bearing housing and movable with respect to the bearing housing and arranging at least one structural element between adjacent pairs of the plurality of elastomer sections.

Although aspects of the subject matter disclosed herein has been stated hereinabove, and which is achieved in whole or in part by the presently disclosed subject matter, other aspects will become evident as the description proceeds when taken in connection with the accompanying drawings as best described hereinbelow.

### BRIEF DESCRIPTION OF THE DRAWINGS

FIG. 1 is a cut-away perspective view illustrating a conventional non-partitioned elastomeric journal bearing.

FIGS. 2A and 2B are finite-element analyses illustrating stress and strain distributions of a conventional non-partitioned elastomeric journal bearing under loaded conditions.

FIGS. 3A and 3B are cut-away perspective views illustrating a partitioned elastomeric journal bearing according to an embodiment of the presently disclosed subject matter.

FIGS. 4A and 4B are finite-element analyses illustrating stress and strain distributions of a partitioned elastomeric journal bearing according to an embodiment of the presently disclosed subject matter.

FIG. 5 is a graph illustrating results from a fatigue comparison test between a conventional non-partitioned elastomeric journal bearing and a partitioned elastomeric journal bearing according to an embodiment of the presently disclosed subject matter.

FIG. 6 is a cutaway end and side view illustrating a partitioned elastomeric journal bearing in an installed state according to an embodiment of the presently disclosed subject matter.

FIG. 7A is a cross section view illustrating a partitioned elastomeric journal bearing compared to a classical non-partitioned journal bearing.

FIG. 7B is a cross section view of a one elastomer section between a structural partition of a partitioned elastomeric journal bearing compared to a a thick unitary elastomer section of classical non-partitioned journal bearing depicting localized bending in the elastomer section during motion.

### DETAILED DESCRIPTION

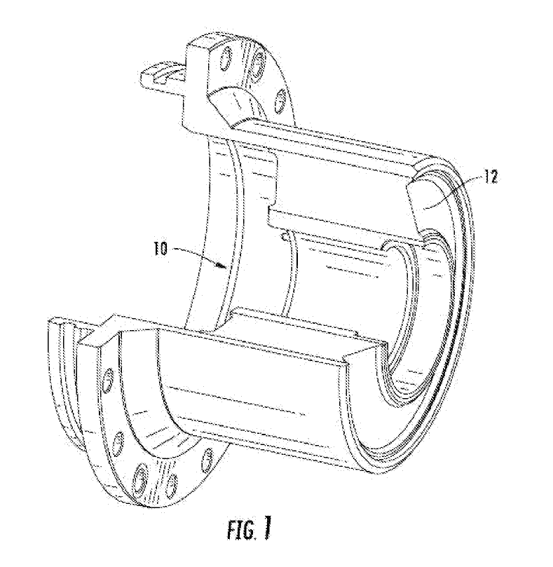

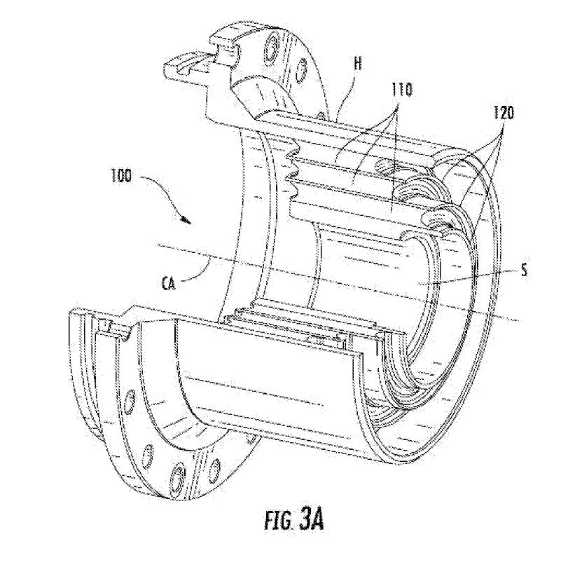

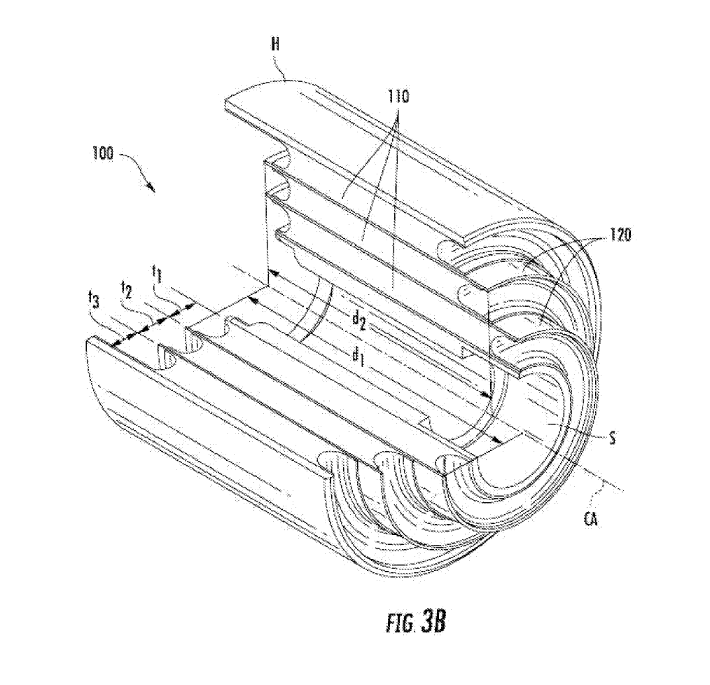

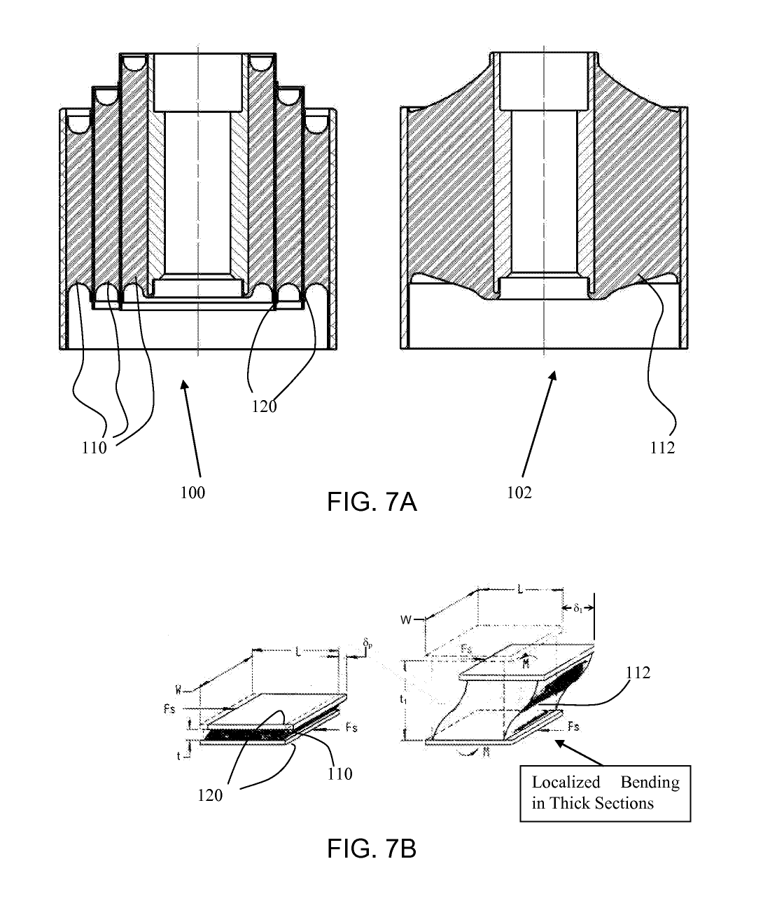

The present subject matter discloses elastomeric journal bearing assemblies, systems and methods. In one aspect, the present subject matter provides an elastomeric journal bearing that incorporates structural partitions within the elastomer section. In one exemplary configuration illustrated in FIGS. 3A and 3B, an elastomeric journal bearing assembly, generally designated 100, comprises a plurality of elastomer sections 110 having a combined size (e.g., length, thickness) that is substantially similar to the size of a unitary elastomer section that is commonly used in such systems (See, e.g., FIGS. 1, 7A and 7B).

FIG. 7A illustrates a cross section of elastomeric journal bearing assembly 100 and non-partitioned journal bearing 102 compared side-by-side. In this comparison, elastomer sections 110 and structural elements 120 are illustrated on elastomeric journal bearing assembly 100. Alternative, the classical non-partitioned journal bearing 102 has a thick, single elastomer section 112 as a unitary elastomer and does not have any structural partitions. As illustrated the combined elastomer sections 110 and structural elements 120 have a similar thickness as that of single elastomer section 112. Single elastomer section 112 has high localized stresses while the combined elastomer sections 110 and structural elements 120 have reduced and distributed stresses as a result of including structural elements 120.

Also illustrated in FIG. 7B is the localized bending of an elastomer section 110 and structural elements 120 as compared to the localized bending of a single elastomer section 112. FIG. 7B illustrates shear force Fₛ acting upon elastomeric journal bearing assembly 100 and non-partitioned journal bearing 102. Both elastomeric journal bearing assembly 100 and non-partitioned journal bearing 102 each have an identical length L and width W. The thickness t and t₁ are the thickness of elastomer section 110 and elastomer section 112, respectively. Shear force Fₛ causes elastomer section 110 and structural elements 120 to displace by a displacement distance δₚ. Shear force Fₛ causes elastomer section 112 to displace by a displacement distance δ₁. The difference between the displacement distance δ₁ compared to the displacement distance δₚ is substantially greater. However, the sum of all displacement distances δₚ in elastomeric journal bearing assembly 100 are equal to displacement distance δ₁ for non-partitioned journal bearing 102. The sum of all displacement distances δₚ in elastomeric journal bearing assembly 100 is equal to δₚ₁+δₚ₂+ . . . δₚₘ, where displacement distance δₚ₁ is a first displacement distance δₚ, and δₚₘ is the last displacement distance δₚ. As illustrated, elastomer section 112 has significant localized bending as compare to elastomer section 110. Additionally, the displacement distance displacement distance δ₁ is sufficient to induce a moment M in non-partitioned journal bearing 102.

In the configuration illustrated in FIGS. 3A and 3B, elastomer sections 110 are substantially annular sections arranged concentrically between a housing H and a shaft S having a center axis CA. Although FIGS. 3A and 3B illustrate elastomer sections 110 as being divided into concentric annular sections, those having skill in the art will recognize that the principles discussed herein are not limited to annular/tubular geometries.

In some embodiments, at least one structural element 120 is arranged between adjacent pairs of the plurality of elastomer sections 110. Referring again to FIGS. 3A and 3B, elastomer sections 110 and structural elements 120 are arranged together in a layered, alternating arrangement about the center axis CA. In some embodiments, structural elements 120 each comprise thin, rigid, non-elastomeric partition elements (e.g., metals, plastics, composites, or combinations thereof) arranged between two of concentric elastomer sections 110. Structural elements 120 can be bonded to elastomer sections 110, such as by arranging structural elements 120 between adjacent pairs of elastomer sections 110 during the molding and/or curing process. Alternatively, adhesives or other bonding agents can be used to couple structural elements 120 to elastomer sections 110, or in yet further alternative implementations, elastomer sections 110 can be sized such that they are press-fit within and/or about associated structural elements 120. In any arrangement, structural elements 120 help to couple elastomer elements 110 together while still providing structural partitions between elastomer elements 110.

In such arrangements, partitioned elastomer sections 110 are able to provide a variety of beneficial attributes to elastomeric journal bearing assembly 100. In some embodiments, dividing the elastomer element of elastomeric journal bearing assembly 100 into a plurality of elastomer sections 110 and adding structural elements 120 between adjacent elastomer sections 110 reduces the direct tensile stress for a given strain in the elastomer. The configuration reduces surface tensile stresses on the elastomer, and it reduces elastomer section bending. Furthermore, where structural elements 120 comprise materials with comparatively high thermal conductivity (e.g., metal partitions), elastomeric journal bearing assembly 100 exhibits localized heat dissipation within the elastomer section, improved heat dissipation by conduction of heat through structural elements 120, and heat transfer from one external surface to the opposite external surface.

Regarding stresses in the elastomer sections 110, in some embodiments the interstitial addition of structural elements 120 (e.g., partitions) between elastomer sections 110 reduce the thickness-to-length ratio of each of elastomer sections 110, which correspondingly reduces the cross-corner tension angle at each of elastomer sections 110. Furthermore, the addition of structural elements 120 reduces the direct tensile stress in the elastomer of elastomer sections 110 that results from shear displacement of elastomer sections 110 (e.g., due to axial displacement of center shaft S with respect to housing H). In this way, the plurality of elastomer sections 110 are configured to more efficiently redistribute stresses throughout the depth of elastomeric journal bearing assembly 100.

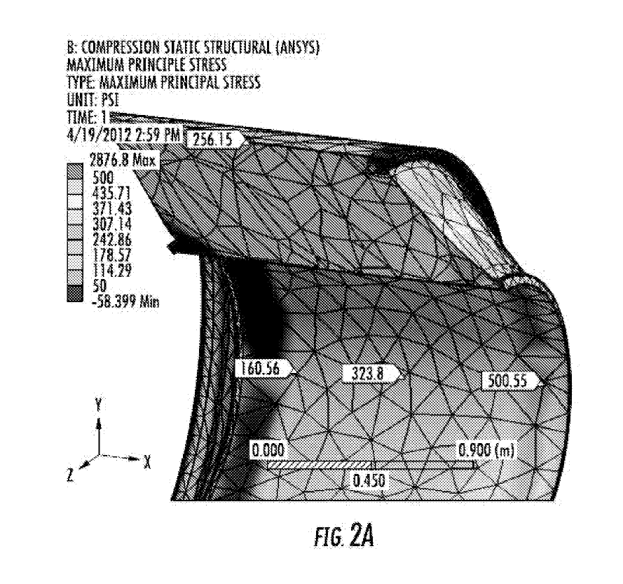

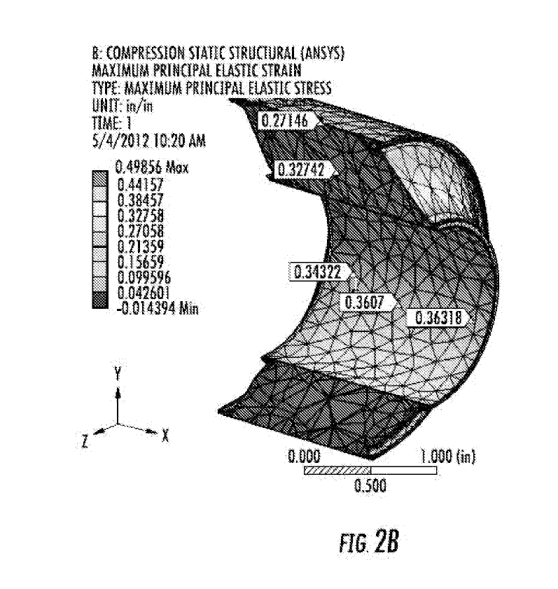

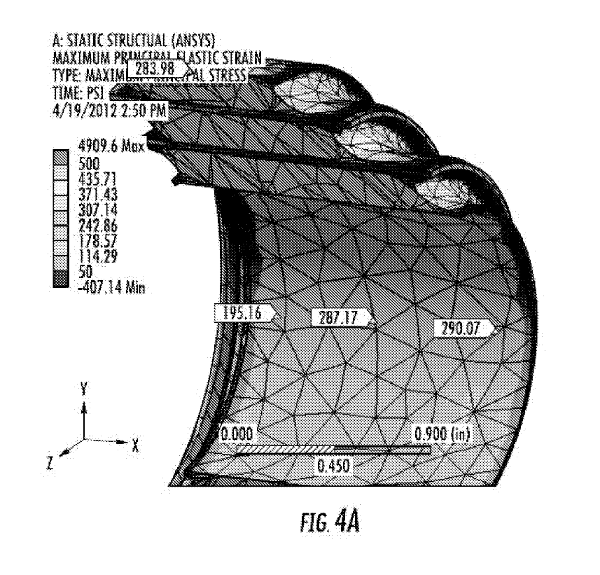

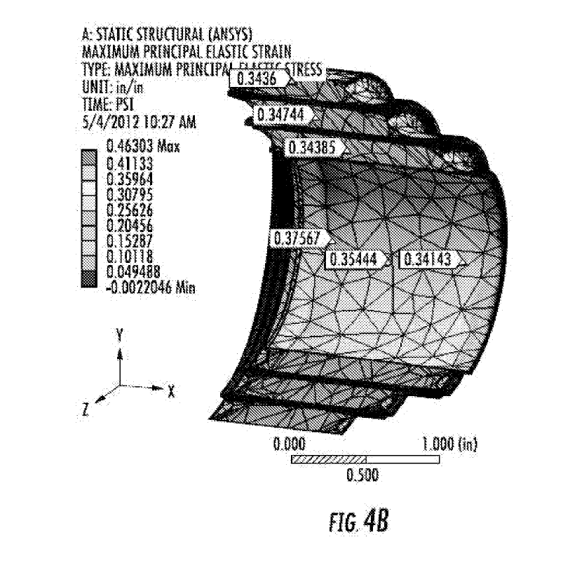

As illustrated in FIGS. 4A and 4B, the principle stresses developed within an exemplary configuration of elastomeric journal bearing assembly 100 during normal operation are relatively less concentrated than the stresses that are experienced in a conventional elastomeric journal bearing (See, e.g., FIGS. 2A and 2B). In the configuration illustrated, the maximum tensile stresses experienced in elastomeric journal bearing assembly 100 compared to conventional elastomeric journal bearing 10 with a unitary elastomer are reduced from over 500 psi to around 290 psi, for a reduced stress of about 42%, and the maximum strains are comparable between the two configurations. Preferably, the reduced tensile stress in this comparison is about 10% or greater, and about 60% or greater for a thickness to length ratio of less than equal to about 0.1. The reduction in tensile stress is related to the thickness and length of elastomer section 110. Elastomer sections 110 with a significant thickness to length ratios (e.g., greater than 0.4) will have a greater cross-corner tension angle which increases the elastomer stress. In the configuration illustrated in FIGS. 4A and 4B elastomeric journal bearing assembly 100 does not substantively change the total assembly's maximum strain from that of conventional elastomeric journal bearing 10 having a unitary elastomer. In the comparison of the configurations for elastomeric journal bearing assembly 100 and conventional elastomeric journal bearing 10, both have the same envelope and take up the same area.

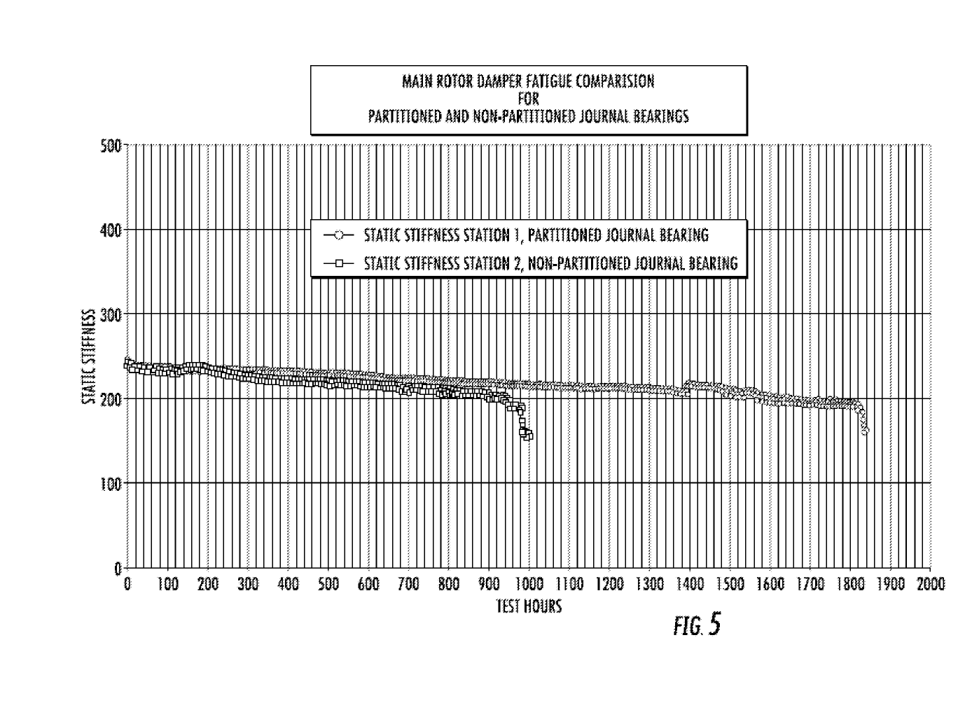

Elastomeric journal bearing assembly 100 reduces direct tensile stress in the elastomer of elastomer sections 110 thereby resulting in an improvement in the fatigue life and damage propagation performance of elastomer sections 110. For instance, FIG. 5 illustrates the comparison of test data for a conventional non-partitioned journal bearing (e.g., elastomeric journal bearing 10) and an elastomeric journal bearing assembly 100 that were subjected for to endurance testing for damper fatigue. Referring to FIG. 5, the endurance testing shows a test life of 1,000 test hours for the conventional non-partitioned journal bearing when separation of the elastomer section occurred in the elastomer section. By comparison, a partitioned elastomeric journal bearing designed to incorporate on the elastomer section according to the presently disclosed subject matter (e.g., elastomeric journal bearing assembly 100) shows a test life of greater than 1,800 test hours. Those of skill in the art will recognize that improving the elastomer fatigue performance as disclosed herein provides for an increase in the service life of the elastomer section.

Regarding the particular geometry of elastomeric journal bearing assembly 100, in one configuration, the distribution of direct tensile stress and/or surface tensile stress is achieved by configuring elastomer sections 110 to have substantially the same radial thickness. In the configuration shown in FIG. 3B, a first thickness t₁ of an innermost of elastomer sections 110 is substantially equivalent to a second thickness t₂ and a third thickness t₃ of the next two of elastomer sections 110. In such a configuration, the total depth of elastomeric journal bearing assembly 100 is divided substantially evenly among the plurality of elastomer sections 110 to help distribute the stresses among elastomer sections 110.

In alternate configurations, the geometry of each of elastomer sections 110 is specifically designed so that each of elastomer sections 110 defines a substantially similar total surface shear area. As illustrated in FIG. 3B, elastomer sections 110 are configured to have a “stepped” geometry, wherein the innermost of the elastomer sections 110 has a first length d₁, the next most inner of elastomeric sections 110 has a relatively shorter second length d₂, and each successive section has a progressively shorter length. In other words, for at least two of the plurality of elastomer sections 110, a first of elastomer section 110 positioned relatively nearer to center axis CA has a longer axial length than a second of elastomer section 110 positioned relatively farther from center axis CA. In this way, as the circumference of each successive elastomer section 110 increases, the axial length decreases (e.g., according to a substantially inverse proportional relationship) so that the total surface area of each of elastomer section 110 remains substantially consistent. This continues for as many n elastomer sections 110 as used. That is, the plurality of elastomer sections 110 each have different axial lengths where the n^{th} of the plurality of elastomer sections 110 positioned relatively nearer to the center axis CA has a longer axial length dₙ than the axial length dₙ₊₁ of an n^{th}+1 of the plurality of elastomer sections 110 positioned relatively farther from the center axis CA.

In some embodiments, the addition of structural elements 120 further acts to locally dissipate heat within elastomer sections, distribute heat within the elastomeric journal bearing assembly 100 as a whole, and transfer external heat through the portioned journal bearing 100 from one exposed structural surface to the opposing side. In the configurations illustrated in FIGS. 3A and 3B, structural elements 120 are configured to extend beyond the axial edges of at least one of an adjacent pair of elastomer sections 110. This difference in lengths of structural elements 120 can be achieved by inserting structural elements 120 with each having an axial length that is longer than the largest axial length of elastomer sections 110. Alternatively, the ends of structural elements 120 are configured to extend beyond the ends of adjacent elastomer sections 110 where the elastomeric journal bearing assembly 100 has the “stepped” configuration discussed above and illustrated in FIGS. 3A and 3B.

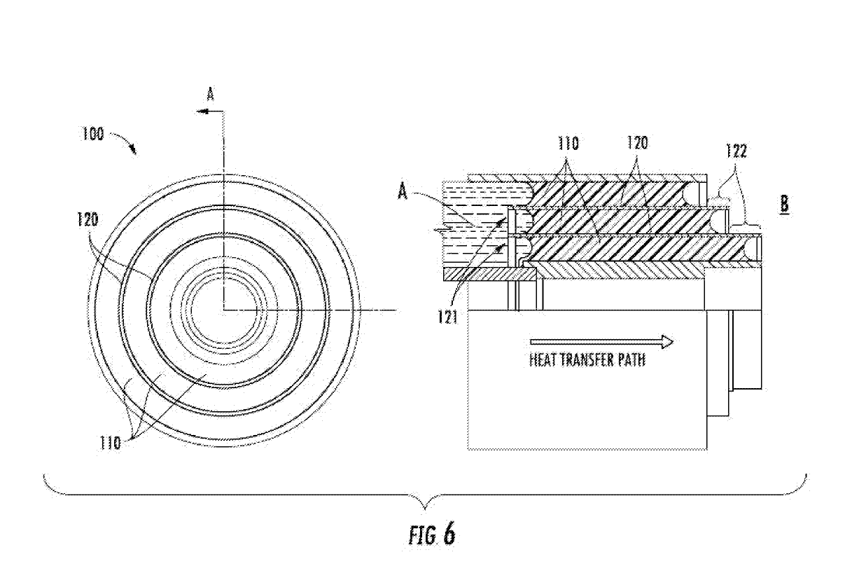

In one exemplary implementation shown in FIG. 6, the axial length for a given one of structural elements 120 is equal to or greater than that of an adjacent one of elastomer sections 110 positioned relatively nearer to center axis CA. Additionally, the axial length of the given one of structural elements 120 is greater than that of a second of the plurality of elastomer sections 110 positioned relatively farther from center axis CA. In this configuration, the edges of structural elements 120 extend beyond the edges of at least one of the adjacent elastomer sections 110 such that they are at least partially exposed to the surrounding environment. In this configuration, structural elements 120 are rigid shims extending into the internal and external environments and are capable of dissipating and/or transferring heat thereto. As used herein, dissipating heat includes the distribution and transference of heat by structural element 120 is capable of heat dissipation between at least two environments positioned adjacently to one another, and the heat dissipation is between either an internal and external environment or an external and external environment. Thus, structural element 120 is capable heat dissipation when at least two of the environments are an external environment positioned adjacent to one another and the heat dissipation is therebetween. Additionally, structural element 120 is capable heat dissipation when at least one of the environments is an external environment positioned adjacent to an internal environment and the heat dissipation is from the internal environment to the external environment.

In the exemplary configuration illustrated in FIG. 6, the elastomeric journal bearing assembly 100 is provided between two different environments (e.g., in a system in which an enclosed, first fluid-filled cavity A is separated from a second environment B that is open to ambient air). In the arrangement illustrated, structural elements 120 comprise first exposed ends 121 that extend beyond the axial edges of at least one adjacent elastomer sections 110 into first fluid-filled cavity A, and/or structural elements 120 further comprise second exposed ends 122 that extend beyond the axial edges of at least one adjacent elastomer sections 110 into second environment B. In this way, the first and second exposed ends 121 and 122 are configured to help dissipate and/or transfer heat from one environment on one side of elastomeric journal bearing assembly 100 (e.g., from the fluid in first fluid-filled cavity A) to the second environment on the other side (e.g., to an open-air environment of second environment B). This enhanced heat transfer relieves thermal gradients along the length of the elastomeric journal bearing assembly 100 and further helps to reduce fatigue and increase the service life of the elastomeric journal bearing assembly 100.

Methods to manufacture an elastomeric journal bearing assembly or assemblies such as those disclosed herein are also envisioned according to this disclosure.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. An elastomeric journal bearing assembly comprising:
a plurality of elastomer sections arranged about a center axis; and
at least one structural element arranged between an adjacent pair of the plurality of elastomer sections.

2. The elastomeric journal bearing assembly of claim 1, wherein each of the plurality of elastomer sections has a substantially similar thickness.

3. The elastomeric journal bearing assembly of claim 1, wherein the plurality of elastomer sections comprise substantially annular sections arranged concentrically about the center axis.

4. The elastomeric journal bearing assembly of claim 3, wherein at least two of the plurality of elastomer sections have different axial lengths, wherein a first of the plurality of elastomer sections positioned relatively nearer to the center axis has a longer axial length than a second of the plurality of elastomer sections positioned relatively farther from the center axis.

5. The elastomeric journal bearing assembly of claim 3, wherein of the plurality of elastomer sections each have different axial lengths, wherein a n^{th} of the plurality of elastomer sections positioned relatively nearer to the center axis has a longer axial length than an n^{th}+1 of the plurality of elastomer sections positioned relatively farther from the center axis.

6. The elastomeric journal bearing assembly of claim 1, wherein each of the plurality of elastomer sections has a substantially similar total surface area.

7. The elastomeric journal bearing assembly of claim 1, wherein the plurality of elastomer sections are bonded to the at least one structural element.

8. The elastomeric journal bearing assembly of claim 1, wherein the at least one structural element comprises a non-elastomeric material.

9. The elastomeric journal bearing assembly of claim 1, wherein the at least one structural element comprises a metallic material.

10. The elastomeric journal bearing assembly of claim 9, wherein the at least one structural element comprises a metal sheet element.

11. The elastomeric journal bearing assembly of claim 1, wherein the at least one structural element extends beyond an axial edge of at least one of the adjacent pair of the plurality of elastomer sections.

12. The elastomeric journal bearing assembly of claim 11, wherein the at least one structural element has an axial length that is greater than an axial length of the at least one of the adjacent pair of the plurality of elastomer sections.

13. The elastomeric journal bearing assembly of claim 12, wherein each of the at least one structural element is arranged between two elastomer sections that are arranged concentrically about the center axis;
wherein an axial length of each of the at least one structural element is equal to or greater than an axial length of a first of the two elastomer sections positioned relatively nearer to the center axis; and
wherein the axial length of the at least one structural element is greater than an axial length of a second of the plurality of elastomer sections positioned relatively farther from the center axis.

14. The elastomeric journal bearing assembly of claim 1, wherein the structural element is a rigid shim extending into the internal and external environments.

15. The elastomeric journal bearing assembly of claim 14, wherein the structural element is capable of heat dissipation between at least two environments positioned adjacently to one another.

16. The elastomeric journal bearing assembly of claim 15, wherein at least two of the environments are an external environment positioned adjacent to one another and the heat dissipation is therebetween.

17. The elastomeric journal bearing assembly of claim 15, wherein at least one of the environments is an external environment positioned adjacent an internal environment and the heat dissipation is from the internal environment to the external environment.

18. The elastomeric journal bearing assembly of claim 1, wherein the elastomeric journal bearing assembly provides for a reduction of tensile stress and localized bending of the elastomer sections.

19. The elastomeric journal bearing assembly of claim 19, wherein the reduction of tensile stress is about 10% over a elastomeric journal bearing having a unitary elastomer.

20. The elastomeric journal bearing assembly of claim 19, wherein the reduction of tensile stress is about 60% over a elastomeric journal bearing having a unitary elastomer with a thickness to length ratio of less than equal to 0.1.

21. The elastomeric journal bearing assembly of claim 20, wherein the reduction of tensile stress is about 42%.

22. The elastomeric journal bearing assembly of claim 19, further comprising a reduction in localized bending.

23. An elastomeric journal bearing system comprising:
a bearing housing;
a shaft positioned within the bearing housing and movable with respect to the bearing housing;
a plurality of elastomer sections arranged within the bearing housing about the shaft; and
at least one structural element arranged between adjacent pairs of the plurality of elastomer sections.

24. The elastomeric journal bearing system of claim 23, wherein the plurality of elastomer sections comprise substantially annular sections arranged concentrically about the shaft

25. The elastomeric journal bearing system of claim 24, wherein at least two of the plurality of elastomer sections have different axial lengths, wherein a first of the plurality of elastomer sections positioned relatively nearer to the shaft has a longer axial length than a second of the plurality of elastomer sections positioned relatively farther from the shaft.

26. The elastomeric journal bearing system of claim 24, wherein an axial length of each of the at least one structural element is equal to or greater than an axial length of a first of the two elastomer sections positioned relatively nearer to the shaft; and
wherein the axial length of the at least one structural element is greater than an axial length of a second of the plurality of elastomer sections positioned relatively farther from the shaft.

27. A method for making an elastomeric journal bearing, the method comprising:
arranging a plurality of elastomer sections within a bearing housing about a shaft that is positioned within the bearing housing and movable with respect to the bearing housing; and
arranging at least one structural element between adjacent pairs of the plurality of elastomer sections.

28. The method of claim 27, wherein arranging the plurality of elastomer sections about the center axis comprises arranging substantially annular sections concentrically about the center axis.

29. The method of claim 27, wherein arranging the plurality of elastomer sections about the center axis comprises:
positioning a first of the plurality of elastomer sections relatively nearer to the center axis; and
positioning a second of the plurality of elastomer sections positioned relatively farther from the center axis;
wherein the first of the plurality of elastomer sections has a longer axial length than the second of the plurality of elastomer sections.

30. The method of claim 27, wherein arranging the at least one structural element between adjacent pairs of the plurality of elastomer sections comprises bonding the at least one structural element to the plurality of elastomer sections, wherein the structural element is capable of heat dissipation.
